(19) United States
(12) Patent Application Publication
(10) Pub. No.: US 2003/0099462 A1
(43) Pub. Date: May 29, 2003

(54) Program video-recording apparatus, program video-recording method, and program receiving apparatus

(76) Inventor: Toshiki Matsugami, Fuchu-shi (JP)

Correspondence Address: PILLSBURY WINTHROP, LLP, P.O. BOX 10500, MCLEAN, VA, 22102, US

(21) Appl. No.: 10/237,180

(22) Filed: Sep. 9, 2002

(30) Foreign Application Priority Data
Nov. 27, 2001 (JP) 2001-361314

(51) Int. Cl. H04N 5/92; H04N 7/00; G06F 3/00; G06F 13/00

(52) U.S. Cl. 386/83; 725/58

(57) ABSTRACT

A program video-recording apparatus comprises a setting section which sets reservation information, a reserved video-recording section which correlates the reservation information set at the setting section with attribute information added to input program information and automatically retrieves and video-records a program likely to be video-recorded, and a notice section which gives notice that a program has been video-recorded by the reserved video-recording section.

### CROSS-REFERENCE TO RELATED APPLICATIONS

This application is based upon and claims the benefit of priority from the prior Japanese Patent Application No. 2001-361314, filed Nov. 27, 2001, the entire contents of which are incorporated herein by reference.

### BACKGROUND OF THE INVENTION

1. Field of the Invention

This invention relates to a program video-recording apparatus which automatically records a program that meets the conditions set by the user. This invention also relates to a program video-recording method which automatically records a program that meets the conditions set by the user. Furthermore, this invention relates to a program receiving apparatus which automatically receives a program that meets the conditions set by the user.

2. Description of the Related Art

As is generally known, satellite-based digital TV broadcasting has been put to practical use in recent years. In digital TV broadcasting, a compatible digital broadcast receiving apparatus enables the user not only to view TV programs but also to be provided with a great variety of pieces of program information through data broadcasting.

The program information includes not only service numbers, service names, program names but also information about the content of the programs (e.g., highlights, outlines, or performers) and information about the form of broadcasting (e.g., viewing fees, video-recording possible/impossible, or resolution). The user can operate the digital broadcast receiving apparatus to get the desired information.

As has been disclosed in, for example, Jpn. Pat. Appln. KOKAI Publication No. 2000-295554, a program video-recording apparatus has been developed which, when the user sets various conditions characterizing the desired program to be recorded in the form of reservation information, collates the reservation information with the received program information and automatically retrieves and video-records a program likely to be video-recorded.

With the program video-recording apparatus disclosed in the KOKAI publication, however, even when there is a newly automatically video-recorded program, the user might be unaware of the fact and miss it. There is another problem: if the user does not view many programs automatically video-recorded, he or she cannot judge whether they are the desired programs or not.

### BRIEF SUMMARY OF THE INVENTION

It is accordingly an object of the present invention to provide a program video-recording apparatus, a program video-recording method, and a program receiving apparatus which notify the user that there are newly automatically video-recorded programs to prevent the user from being unaware of automatically video-recorded programs and missing them.

According to an aspect of the present invention, there is provided a program video-recording apparatus comprising: a setting section which sets reservation information; a reserved video-recording section which correlates the reservation information set at the setting section with attribute information added to input program information and retrieves and video-records a program to be video-recorded; and a notice section which gives notice that a program has been video-recorded by the reserved video-recording section.

According to another aspect of the present invention, there is provided a program video-recording method comprising: setting reservation information; correlating the set reservation information with attribute information added to input program information and retrieving and video-recording a program to be video-recorded; and giving notice that a program has been video-recorded.

According to still another aspect of the present invention, there is provided a program receiving apparatus comprising: a receiving section which receives a broadcast program and acquires program information and its attribute information; a setting section which sets reservation information; a reserved video-recording section which correlates the reservation information set at the setting section with the attribute information acquired at the receiving section and retrieves and video-records a program to be video-recorded; and a notice section which gives notice that a program has been video-recorded by the reserved video-recording section.

### BRIEF DESCRIPTION OF THE SEVERAL VIEWS OF THE DRAWING

FIG. 1 is a block diagram to help explain a first embodiment of the present invention;

FIG. 2 is a diagram to help explain an example of attribute information in the first embodiment;

FIG. 3 is a diagram to help explain an automatic reservation table in the first embodiment;

FIG. 4 is a flowchart to help explain the operation of the reservation managing section in the first embodiment;

FIG. 5 is a diagram to help explain a program reservation table in the first embodiment;

FIG. 6 is a diagram to help explain the details of the notice section in the first embodiment;

FIG. 7 is a flowchart to help explain a second embodiment of the present invention;

FIG. 8 is a diagram to help explain a representation of the content of programs in the second embodiment;

FIG. 9 is a flowchart to help explain a third embodiment of the present invention;

FIG. 10 is a diagram to help explain a list representation of programs in the third embodiment;

FIG. 11 is a flowchart to help explain a fourth embodiment of the present invention;

FIG. 12 is a diagram to help explain a list representation of programs in the fourth embodiment;

FIGS. 13A to 13C are drawings to help explain a fifth embodiment of the present invention;

FIG. 14 is a flowchart to help explain the operation of the reservation managing section in the fifth embodiment;

FIG. 15 is a drawing to help explain a remote controller in the fifth embodiment;

FIG. 16 is a diagram to help explain an example of displaying a list of programs and the choices for processes in the fifth embodiment;

FIGS. 17A to 17C are drawings to help explain a sixth embodiment of the present invention;

FIG. 18 is a flowchart to help explain the operation of the reservation managing section in the sixth embodiment;

FIG. 19 is a diagram to help explain an example of displaying a list of programs and the choices for processes in the sixth embodiment;

FIG. 20 is a flowchart to help explain a seventh embodiment of the present invention;

FIGS. 21A and 21B are diagrams to help explain examples of displaying a list of programs and the choices for processes in the seventh embodiment;

FIG. 22 is a flowchart to help explain an eighth embodiment of the present invention;

FIGS. 23A and 23B are diagrams to help explain examples of displaying a list of programs and the choices for processes in the eighth embodiment;

FIG. 24 is a flowchart to help explain a ninth embodiment of the present invention;

FIG. 25 is a flowchart to help explain a tenth embodiment of the present invention;

FIGS. 26A and 26B are diagrams to help explain examples of displaying a list of programs and the choices for processes in the tenth embodiment;

FIG. 27 is a flowchart to help explain an eleventh embodiment of the present invention;

FIGS. 28A to 28D are diagrams to help explain examples of displaying a list of programs and the choices for processes in the eleventh embodiment;

FIG. 29 is a flowchart to help explain a twelfth embodiment of the present invention;

FIGS. 30A to 30D are diagrams to help explain examples of displaying a list of programs and the choices for processes in the twelfth embodiment;

FIG. 31 is a flowchart to help explain a thirteenth embodiment of the present invention;

FIG. 32 is a flowchart to help explain a fourteenth embodiment of the present invention; and

FIG. 33 is a flowchart to help explain a fifteenth embodiment of the present invention.

### DETAILED DESCRIPTION OF THE INVENTION

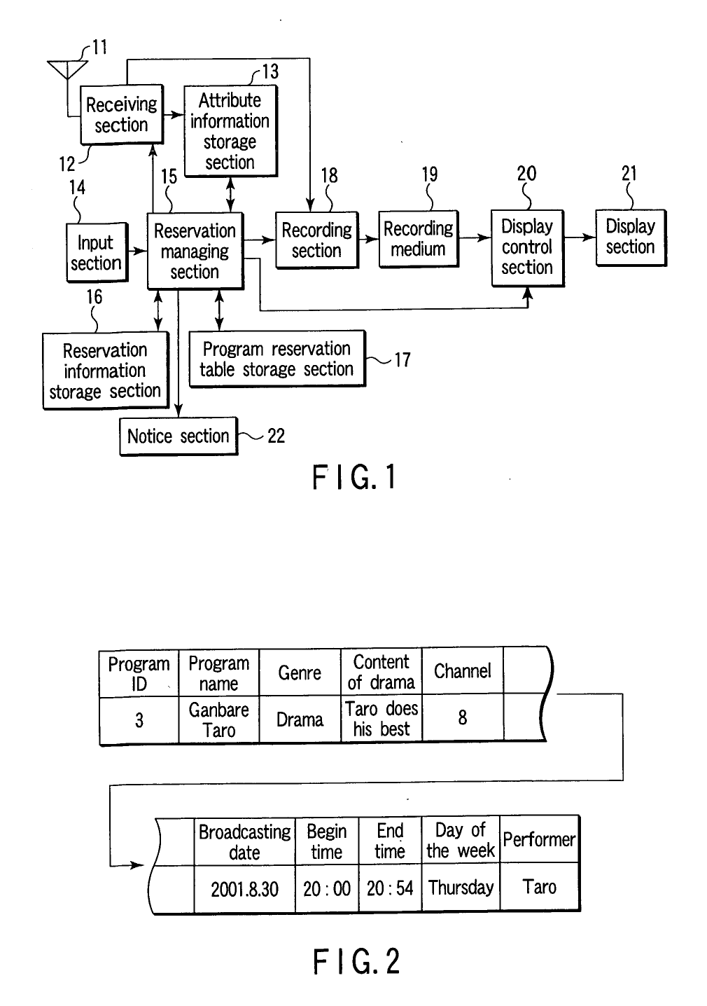

Hereinafter, referring to the accompanying drawings, a first embodiment of the present invention will be explained in detail. In FIG. 1, reference numeral 11 indicates an antenna that receives a digital broadcast signal, 12 a receiving section that extracts the program video data and attribute information from the digital broadcast signal, 13 an attribute information storage section that stores the extracted attribute information, 14 an input section from which the user inputs operation information or reservation information, 15 a reservation managing section that manages the reservation information set by the user, 16 a reservation information storage section that receives the reservation information given by the reservation managing section 15 and stores it in an automatic reservation table, 17 a program reservation table storage section that stores a program reservation table containing information about the times and channels necessary to execute reserved video-recording, 18 a recording section that records program video data onto a recording medium 19, 19 the recording medium, such as a hard disk, 20 a display control section that causes a display section 21 to display the program video data and the attribute information about programs recorded on the recording medium 19, 21 the display section that displays the program video data and the attribute information about programs, and 22 a notice section that notifies the user that there is a newly automatically video-recorded program.

The receiving section 12 receives the program video data and attribute information and outputs the program video data to the recording section 18 and the attribute information to the attribute information storage section 13. The attribute information storage section 13 stores the attribute information supplied from the receiving section 12.

FIG. 2 shows an example of the attribute information. The attribute information includes at least program ID, program name, genre, program content, channel number, broadcasting date, airtime, day of the week, and performer. The program ID is identification information unique to each program.

From the input section 14, the user inputs reservation information that characterizes the program the user wants to video-record. The reservation managing section 15 gives the input reservation information to the reservation information storage section 16, which stores the information in an automatic reservation table.

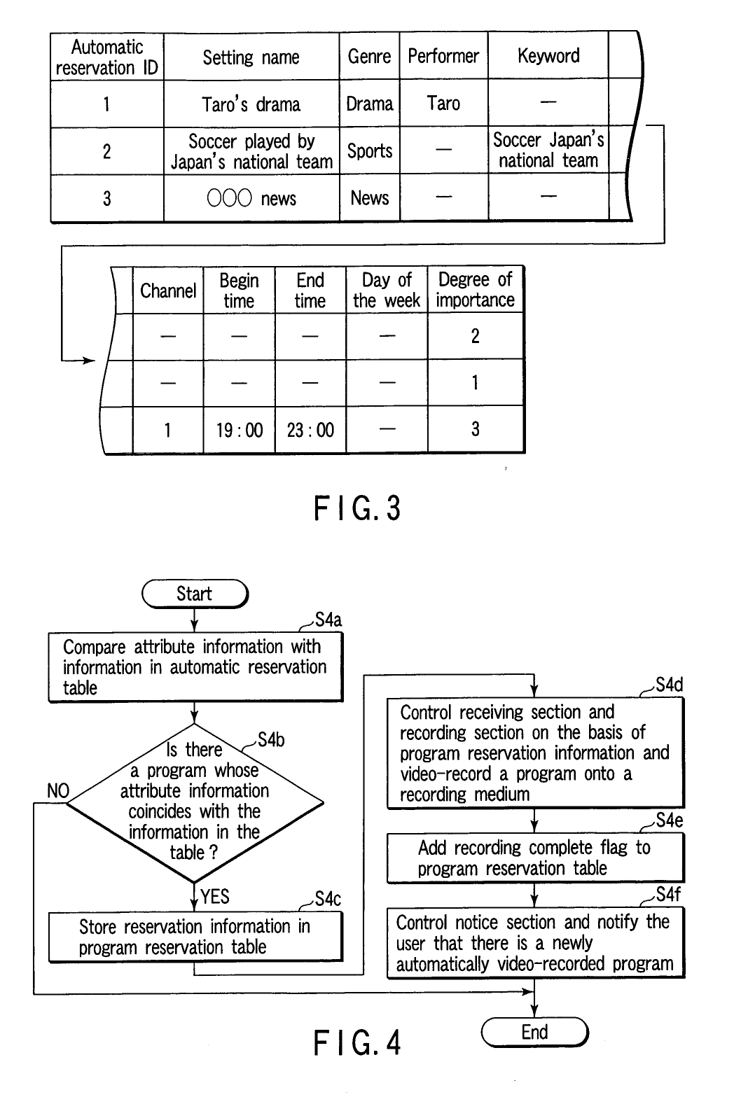

FIG. 3 shows an automatic reservation table. The automatic reservation table is made up of automatic reservation ID, setting name, genre, performer, keyword, channel, airtime, day of the week, the degree of importance of reservation information, and other data. These data items excluding automatic reservation ID are set by the user. The setting name is a name given freely to each piece of reservation information to enable the user to understand the content of the setting easily.

The reservation managing section 15 determines a program reserved for automatic video-recording from the attribute information in the attribute information storage section 13 and the automatic reservation table in the reservation information storage section 16.

FIG. 4 is a flowchart to help explain the operation of the reservation managing section 15. The reservation managing section 15 compares the attribute information with the information in the automatic reservation table (S4a), thereby determining whether there is a program such that the attribute information and the information in the table coincide with one another (S4b). If there is such a program, the reservation managing section 15 stores the necessary information for video-recording reservation, such as time and channel, in the attribute information into the program reservation table storage section 17 (S4c). If there is not such a program, the reservation managing section 15 terminates the process.

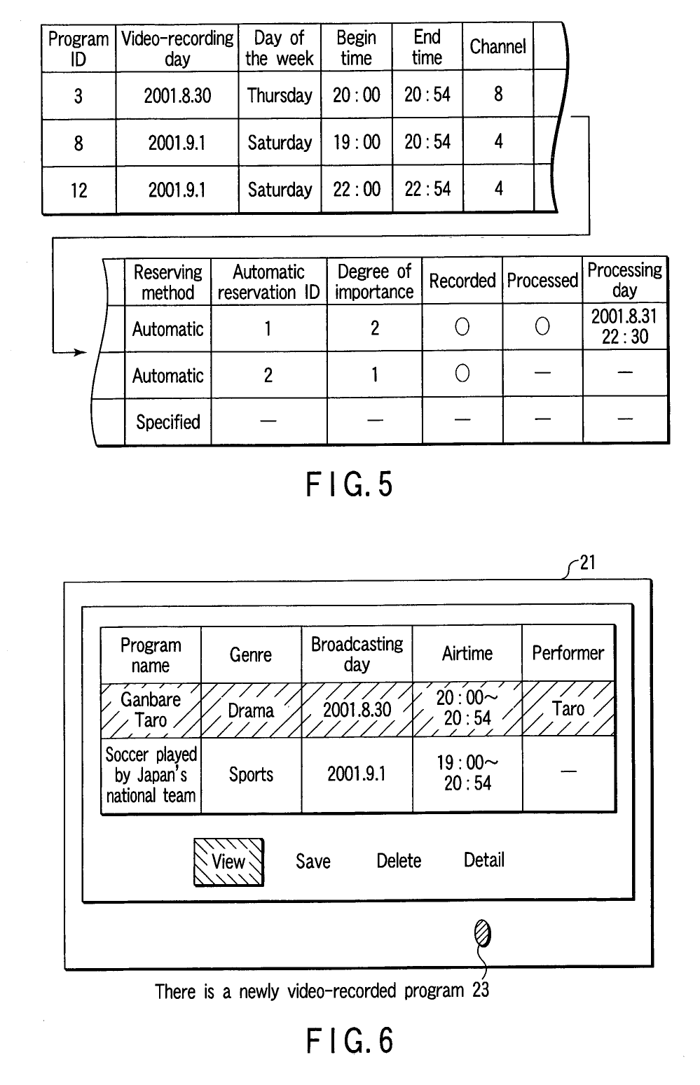

FIG. 5 shows an example of the program reservation table. The program reservation table is made up of program ID, video-recording date, day of the week, begin time, end time, channel, reserving method, automatic reservation ID, degree of importance, recording complete flag, processing complete flag, processing date, and other data. In the reserving method, it is determined whether the reservation is made automatically or according to the user's specification.

The reservation managing section 15 controls the receiving section 12 and recording section 18 on the basis of the information in the program reservation table. The recording section 18 records the received program video data onto the recording medium 19 (S4d).

When the automatically reserved program video data has been recorded on the recording medium 19, the reservation managing section 15 adds a recording complete flag to the reservation table with the corresponding reservation ID in the program reservation table storage section 17 (S4e). The section 15 also causes the notice section 22 to notify the user that there is a newly automatically video-recorded program (S4f).

The notice section 22 is assumed to be, for example, an LED (light-emitting diode) 23 provided on the front panel of the display section 21 as shown in FIG. 6. When there is a newly automatically video-recorded program, the reservation managing section 15 turns on or flashes the LED 23 on the front panel, thereby informing the user of the fact. This lets the user know that there is a newly automatically video-recorded program and prevents the user from missing the video-recorded program.

Next, a second embodiment of the present invention will be explained. The program automatically recorded as described above is merely a program the user might want to video-record and does not necessarily coincide with a program the user really wants to video-record. Therefore, when there are newly video-recorded programs, the user has to choose the desired ones from the programs.

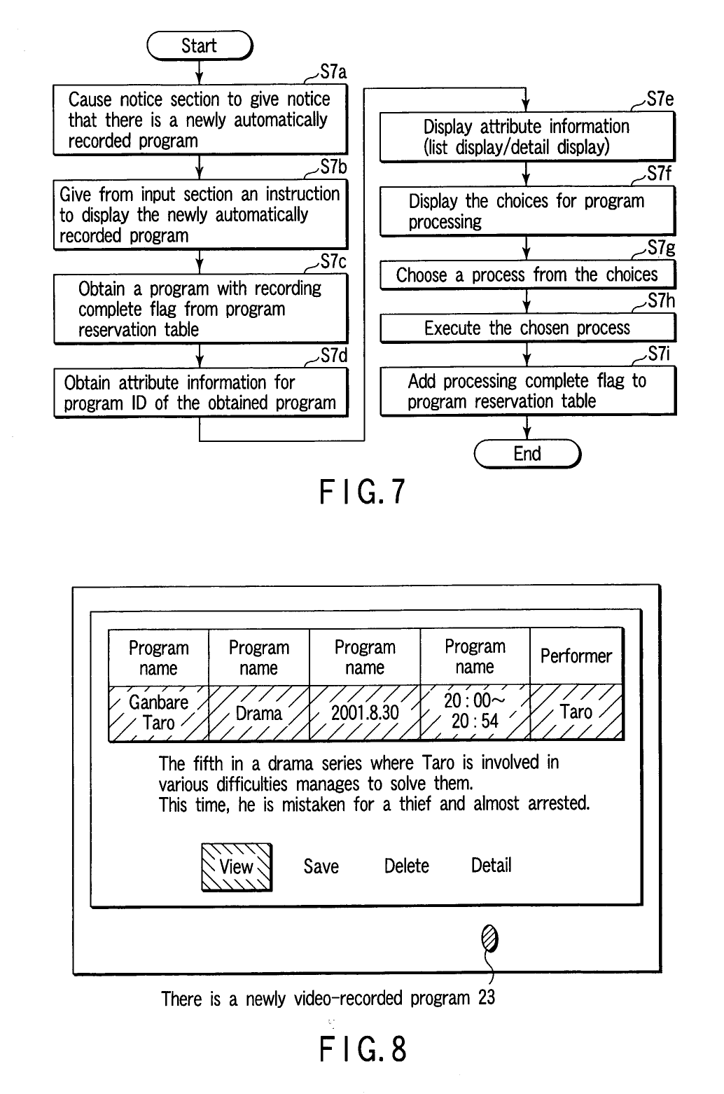

FIG. 7 is a flowchart to help explain the operation ranging from notifying the user of newly automatically video-recorded programs to choosing the desired one. When the notice section 22 has notified the user that there are newly automatically video-recorded programs (S7a), the user inputs from the input section 14 an instruction to display a list of newly automatically video-recorded programs or the content of each video-recorded program (S7b).

The reservation managing section 15, on the basis of the instruction from the input section 14, retrieves the program reservation table with the recording complete flag set from the program reservation table storage section 17 (S7c) and reads the attribute information for the program with the same program ID as that included in the retrieved table from the attribute information storage section 13 (S7d).

In the case of list representation, for example, the display control section 20 is controlled so as to display a list of program names, genres, broadcasting dates, airtimes, performers, and other data and causes the display 21 to display the list as shown in FIG. 6 (S7e).

In the list, for example, the user is prompted to choose the processing of the program indicated by the cursor (corresponding to the shaded portion in FIG. 6). For example, as shown in FIG. 6, the choices are displayed to prompt the user to choose one of them (S7f). The choices include “View” (in the case of viewing right away), “Save” (in the case of viewing later), “Delete” (in the case of deleting at once), and “Detail” (in the case of being unable to make a decision from the list representation, displaying an outline of the program).

When the content of each program is displayed, the choices are similarly displayed as shown in, for example, FIG. 8. The user chooses a process from the choices and inputs it from the input section 14 (S7g).

The reservation managing section 15 controls each section to execute the chosen process (S7h). For example, when “View” has been chosen, the reservation managing section 15 causes the display control section 20 to read the program with the corresponding ID from the recording medium 19 and display the program. After the chosen process has been executed, the reservation managing section 15 adds a processing complete flag to the program reservation table (S7i).

As described above, when there are newly automatically video-recorded programs, a list of the programs or the content of each program is displayed, prompting the user to choose the way of processing each program, which enables the user to choose the desired program and view only the program he or she really wanted to video-record.

Next, a third embodiment of the present invention will be explained. There is another method of displaying newly automatically video-recorded programs. In FIG. 6, a list representation has been given in the order of reservation information. In the third embodiment, however, giving a list representation by genre makes it easier for the user to choose programs.

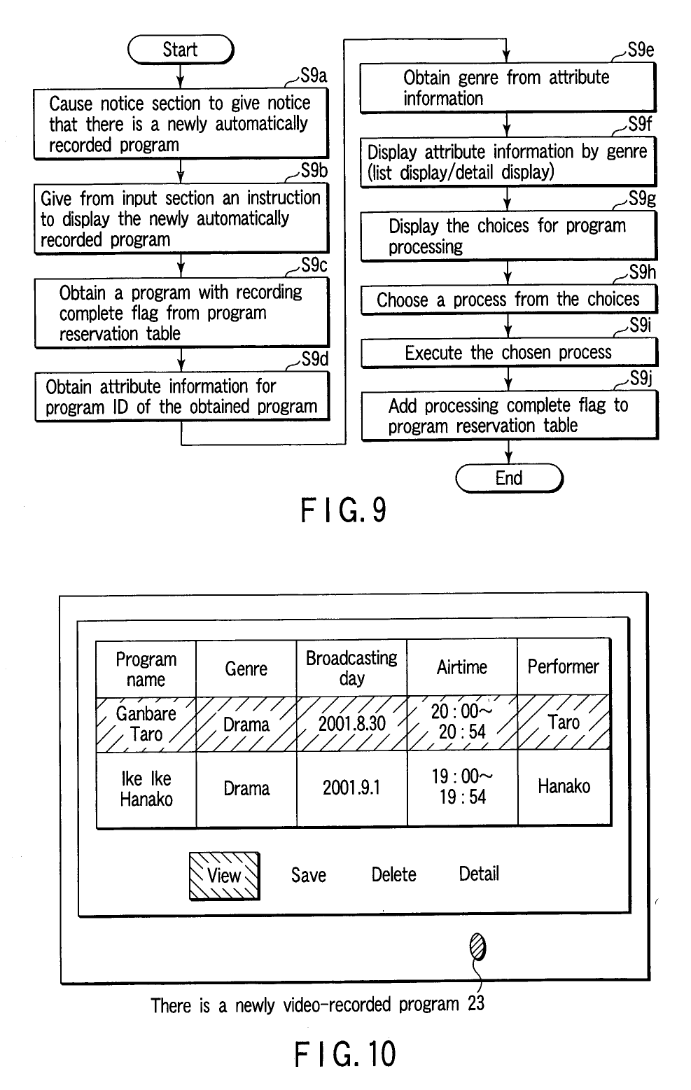

FIG. 9 is a flowchart to help explain the operation of displaying video-recorded programs by genre. When the notice section 22 informs the user that there are newly automatically video-recorded programs (S9a) and the user gives from the input section 14 an instruction to display a list of newly automatically video-recorded programs or the content of each program (S9b), the reservation managing section 15, on the basis of the input from the input section 14, retrieves a program reservation table whose recording complete flag is set from the program reservation table storage section 17 (S9c) and reads the attribute information for the program with the same program ID as that included in the retrieved table from the attribute information storage section 13 (S9d).

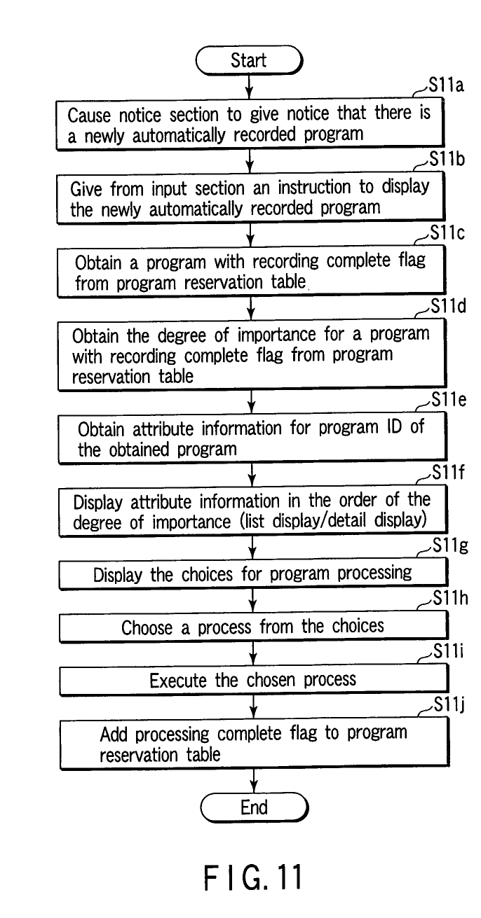

At that time, referring to the genre in the attribute information (S9e), the reservation managing section 15 controls the display control section 20 so as to display a list by genre and cause the display section 21 to display the list (S9f), as shown in FIG. 10. From this point on, step S9q to step S9j are the same as step S7f to step S7i shown in FIG. 7. As described above, displaying by genre makes it easier for the user to choose the desired programs.

Next, a fourth embodiment of the present invention will be explained. In the third embodiment, newly video-recorded programs have been displayed by genre in the attribute information. There is another method of displaying newly video-recorded programs in the order of degree of importance of reserved information. In this method, programs are displayed in the order in which the user thinks they are more important, which makes it easier for the user to choose programs.

FIG. 11 is a flowchart to help explain the operation of displaying video-recorded programs in the order of degree of importance. When the notice section 22 informs the user that there are newly automatically video-recorded programs (S11a) and the user gives from the input section 14 an instruction to display a list of newly automatically video-recorded programs or the content of each program (S11b), the reservation managing section 15, on the basis of the input from the input section 14, retrieves a program reservation table whose recording complete flag is set from the program reservation table storage section 17 (S11c) and further obtain the degree of importance of the reservation information from the program reservation table (S11d).

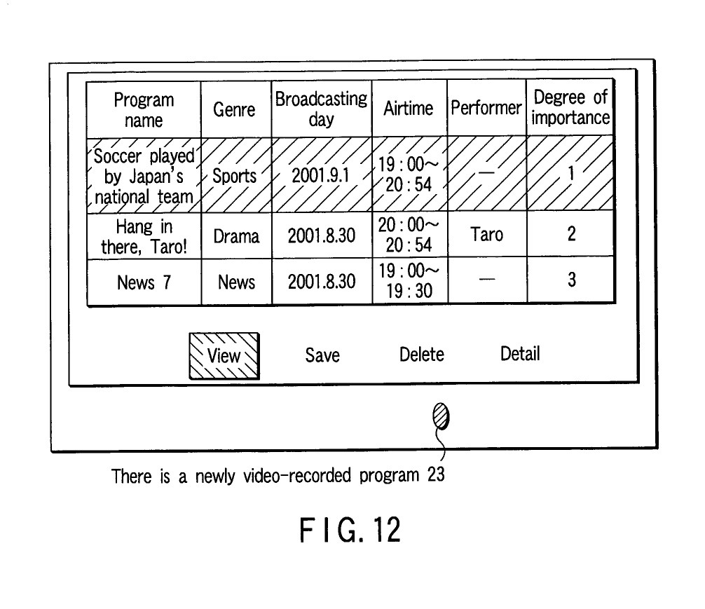

Then, the reservation managing section 15 reads the attribute information with the same ID as that included in the program reservation table from the attribute information storage section 13 (S11e) and controls the display control section 20 so as to display the programs in the order of degree of importance and cause the display section 21 to display the list (S11f), as shown in FIG. 12. From this point on, step S11g to step S11j are the same as step S7f to step S7i shown in FIG. 7. As described above, displaying in the order of degree of importance makes it easier for the user to choose programs.

Next, a fifth embodiment of the present invention will be explained. In an above method, newly video-recorded programs are displayed by genre in the attribute information, which makes it easier for the user to choose programs. There is still another method of notifying the user of newly automatically video-recorded programs by genre.

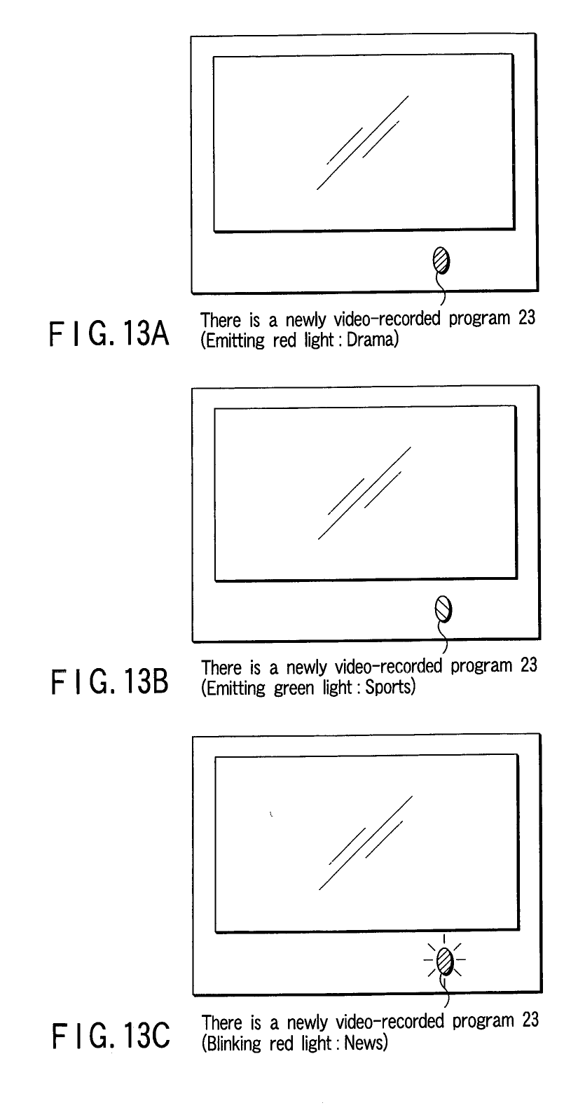

For example, as shown in FIGS. 13A, 13B, and 13C, changing the display color of the LED 23 or the way the LED 23 emits light according to the genre in the attribute information for a newly video-recorded program enables the user to understand at a glance which genre the recorded program belongs to. The switching is done in such a manner that, for example, when a program belongs to drama, the LED 23 emits red light, when a program belongs to sports, it emits green light, and when a program belongs to news, it blinks in red.

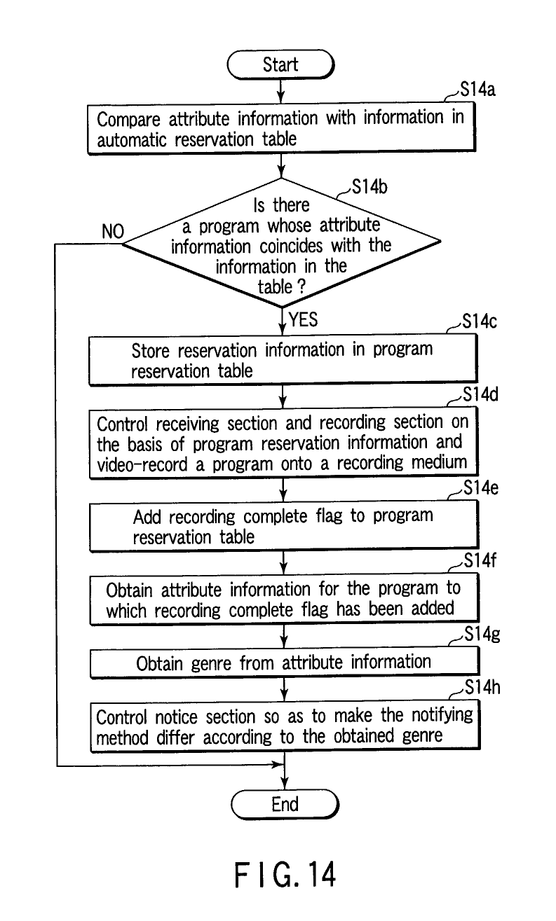

FIG. 14 is a flowchart to help explain the operation of informing the user of video-recorded programs by genre. In FIG. 14, step S14a to step S14e are the same as step S4a to S4e in FIG. 4.

When the automatically reserved program video data has been recorded onto the recording medium 19, the reservation managing section 15 reads from the attribute information storage section 13 the attribute information for the program with the same program ID as that included in the program reservation table with the corresponding reservation ID in the program reservation table storage section 17 (S14f). The reservation managing section 15 then refers to the genre in the attribute information (S14g) and causes the notice section 22 to give different notice according to the genre (S14h).

As described above, informing the user by genre enables the user to understand at a glance which genre a video-recorded program belongs to and makes it easier for the user to choose the desired program.

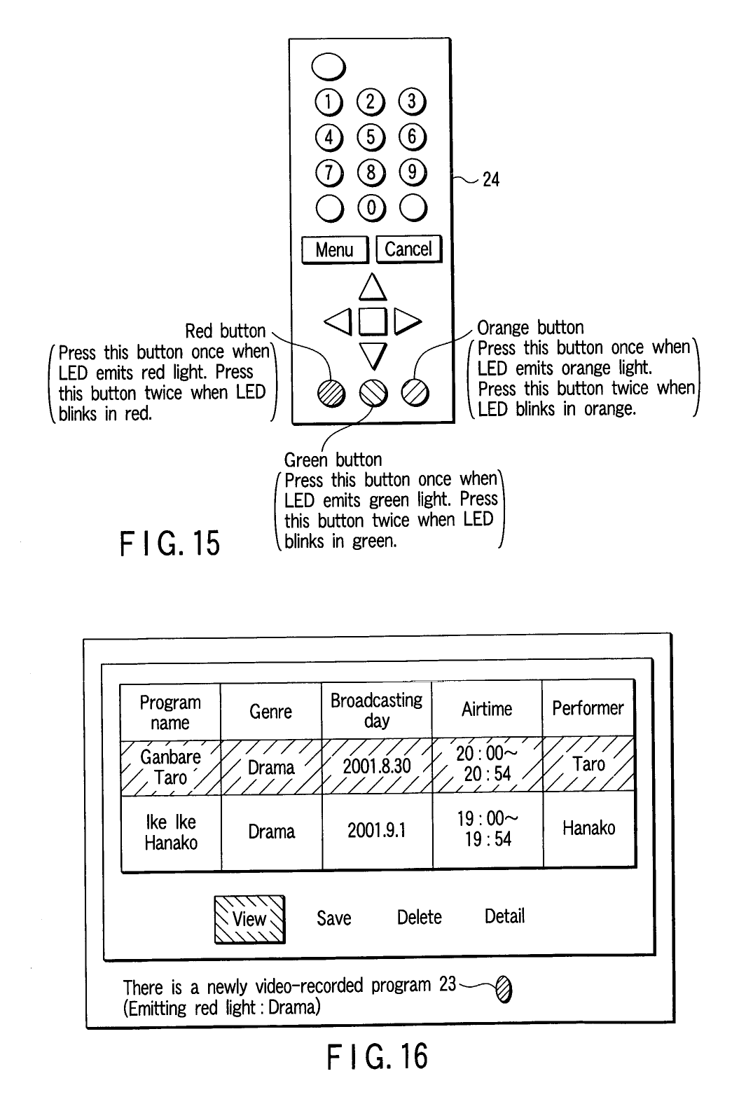

Furthermore, as shown in FIG. 15, selectively pressing the key on a remote controller 24 corresponding to the color emitted from the LED 23 causes the choices for the genres to appear, which prompts the user to choose the desired program.

For example, when the LED 23 is emitting red light, if the user presses the red key on the remote controller 24 once, a list of newly recorded dramas and the choices for processes are displayed, prompting the user to make a choice, as shown in FIG. 16. When the LED 23 is blinking in red, if the user presses the red key on the remote controller 24 twice, a list of newly recorded news is displayed.

As described above, changing the display color of the LED 23 or the way the LED 23 emits light enables the user to know the genre to which the recorded program belongs. When the user presses the key on the remote controller 24 corresponding to the genre, a list for the genre and the detailed content are displayed, which makes it easier for the user to choose the desired program.

Next, a sixth embodiment of the present invention will be explained. In the fifth embodiment, newly video-recorded programs are notified to the user by genre in the attribute information. There is still another method of notifying newly video-recorded programs to the user by the degree of importance of reservation information.

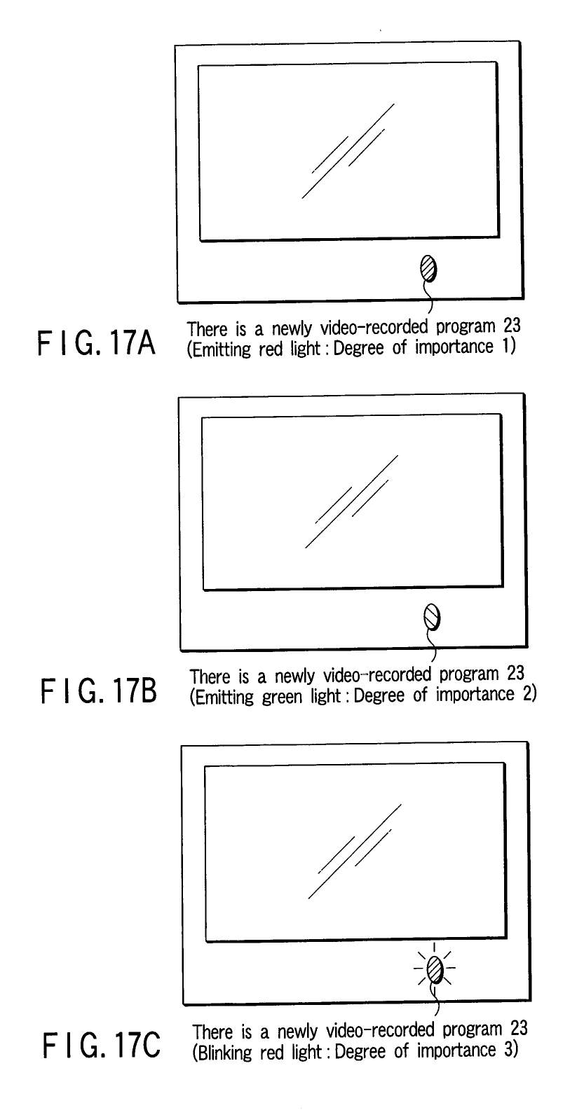

For example, as shown in FIGS. 17A, 17B, and 17C, changing the display color of the LED 23 or the way the LED 23 emits light in the order of degree of importance of the reservation information included in the newly video-recorded program enables the user to understand the degree of importance of the recorded program at a glance, which makes it easier for the user to choose the desired program. The changing is done in such a manner that the LED 23 emits red light, emits green light, and blinks in red in the order of degree of importance of the reservation information.

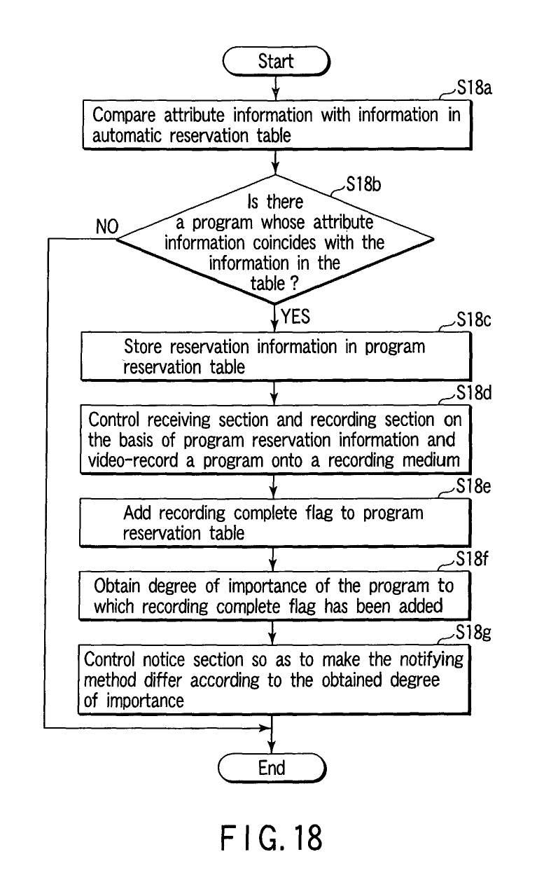

FIG. 18 is a flowchart to help explain the operation of informing the user of video-recorded programs by the degree of importance. In FIG. 18, step S18a to step S18e are the same as step S4a to S4e in FIG. 4.

When the automatically reserved program video data has been recorded onto the recording medium 19, the reservation managing section 15 obtain the degree of importance of the reservation information from the program reservation table with the corresponding reservation ID in the program reservation table storage section 17 (S18f) and causes the notice section 22 to give different notice by the degree of importance (S18g).

As described above, giving notice by the degree of importance enables the user to understand at a glance which degree of importance the video-recorded program belongs to and makes it easier for the user to choose the desired program.

Furthermore, as shown in FIG. 15, selectively pressing the key on the remote controller 24 corresponding to the color emitted from the LED 23 causes the choices for the program with that degree of importance to appear, which prompts the user to choose the desired process.

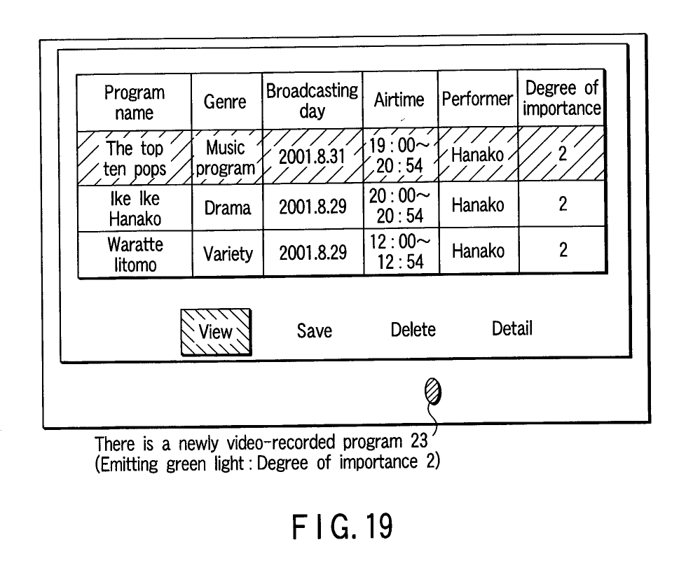

For example, when the LED 23 is emitting green light, if the user presses the green key on the remote controller 24 once, a list of newly recorded programs with degree of importance 2 (or with the second most importance) and the choices for processes are displayed, prompting the user to make a choice, as shown in FIG. 19. When the LED 23 is blinking in red, if the user presses the red key on the remote controller 24 twice, a list of newly recorded programs with degree of importance 3 and the choices for processes are displayed.

As described above, changing the display color of the LED 23 or the way the LED 23 emits light enables the user to know the degree of importance of the recorded program. When the user presses the key on the remote controller 24 corresponding to the degree of importance, a list of the programs with that degree of importance and the detailed content are displayed, which makes it easier for the user to choose the desired program.

Next, a seventh embodiment of the present invention will be explained. The seventh embodiment is still another method of changing the frequency of notice according to the degree of importance of the reservation information. There is a higher probability that programs with a higher degree of importance of the reservation information will be the ones the user wants. Programs with a lower degree of importance of the reservation information might include many programs the user does not want. Therefore, the frequency of notice of programs with a higher degree of importance is made higher and the frequency of notice of programs with a lower degree of importance is made lower, which decreases the chances that the user will make a choice of program processing and therefore reduce the burden on the user.

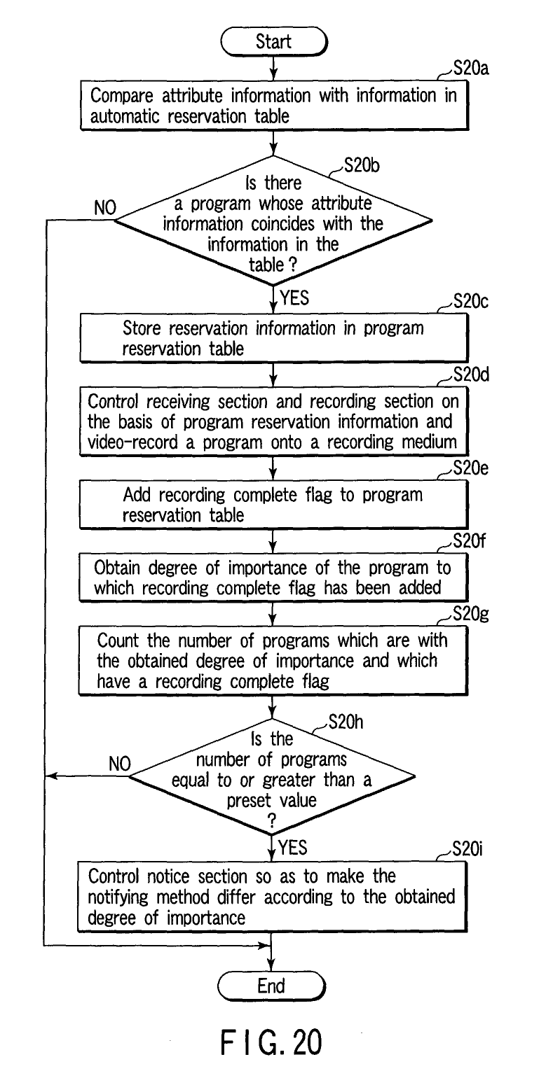

FIG. 20 is a flowchart to help explain the operation of changing the frequency of notice according to the degree of importance of the reservation information. In FIG. 20, step S20a to step S20f are the same as step S18a to step S18f in FIG. 18.

When the automatically reserved program video data has been recorded onto the recording medium 19, the reservation managing section 15 obtain the degree of importance of the reservation information from the program reservation table with the corresponding reservation ID in the program reservation table storage section 17 (S20f).

The reservation managing section 15 counts the number of programs in the program reservation table storage section 17 which have the same degree of importance as the obtain degree of importance and whose recording complete flag is set (S20g). The reservation managing section 15 compares the preset value for each degree of importance with the number of video-recorded programs (S20h). If the program number is equal to or greater than the preset value, the section 15 gives different notice according to the obtained degree of importance (S20i). If the program number is less than the preset value, the section 15 terminates the process.

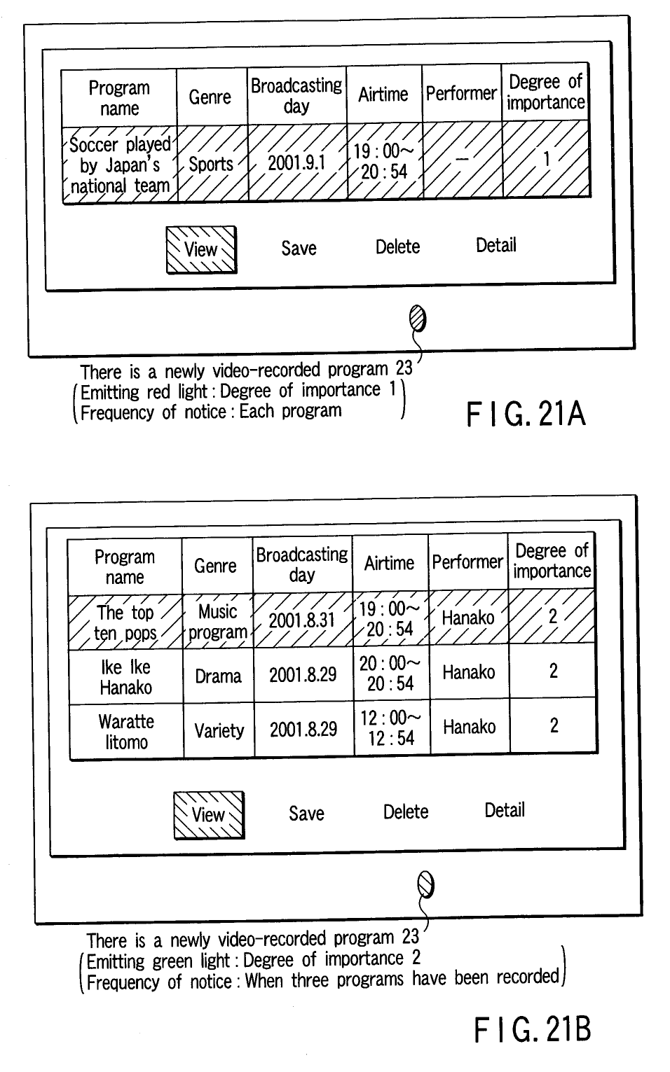

The preset value for each degree of importance is determined as follows. For example, when the degree of importance of a program is high (degree of importance 1), the preset value is set to 1 so as to give notice when a single program is recorded. When the single program has been video-recorded, the notice section 22 is controlled and, as shown in FIG. 21A, the LED 23 is caused to emit red light, thereby notifying the user.

When the degree of importance of a program is low (degree of importance 2), the set value is set to, for example, 3. When three or more programs have been video-recorded, the notice section 22 is controlled and, as shown in FIG. 21B, the LED 23 is caused to emit green light, thereby notifying the user. These preset values may be specified by the user from the input section 14 or be set to default values.

As shown in FIG. 15, selectively pressing the key on the remote controller 24 corresponding to the color emitted from the LED 23 causes the choices for programs with that degree of importance to appear, which prompts the user to choose the desired process.

For example, when the LED 23 is emitting red light, if the user presses the red key on the remote controller 24 once, a list of newly recorded programs with degree of importance 1 and the choices for processes are displayed, prompting the user to make a choice, as shown in FIG. 21A. When the LED 23 is emitting green light, if the user presses the green key on the remote controller 24 once, a list of newly recorded programs with degree of importance 2 and the choice for processes are displayed as shown in FIG. 21B.

As described above, changing the frequency of notice to the user according to the degree of importance decreases the chances that the user will choose the processing of programs with a low degree of importance that are likely to include programs the user does not want. This reduces the burden on the user.

Next, an eighth embodiment of the present invention will be explained. In the eighth embodiment, the user receives notice regardless of the degree of importance when the number of newly video-recorded programs has exceeded a preset value, which reduces the chances that the user will make a choice of processing and thereby decrease the burden on the user.

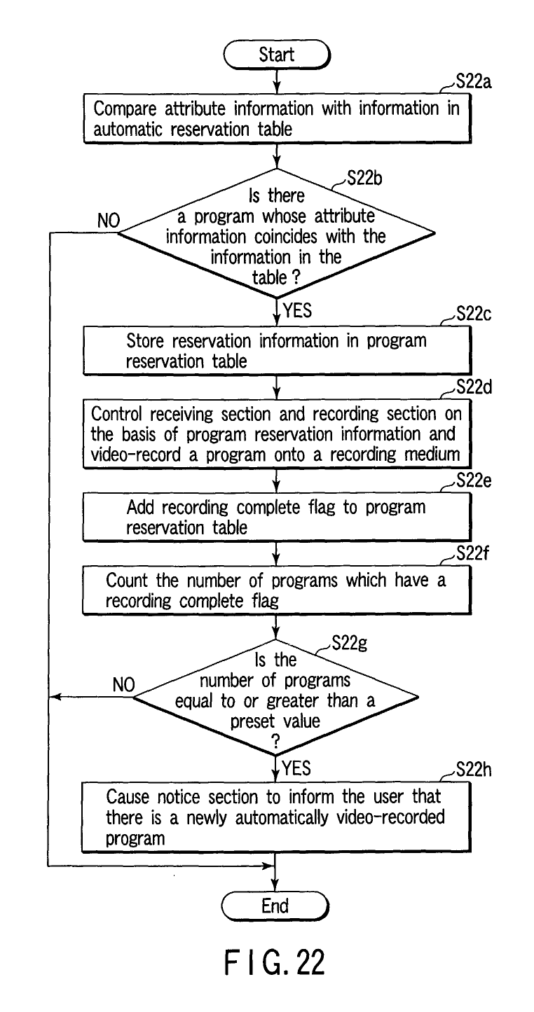

FIG. 22 is a flowchart to help explain the operation of notifying the user when the number of newly video-recorded programs has exceeded a preset value regardless of the degree of importance. In FIG. 22, step S22a to step S22e are the same as step S4a to step S4e in FIG. 4.

When the automatically reserved program video data has been recorded onto the recording medium 19, the reservation managing section 15 adds a recording complete flag to the program reservation table with the corresponding reservation ID in the program reservation table storage section 17 (S22e).

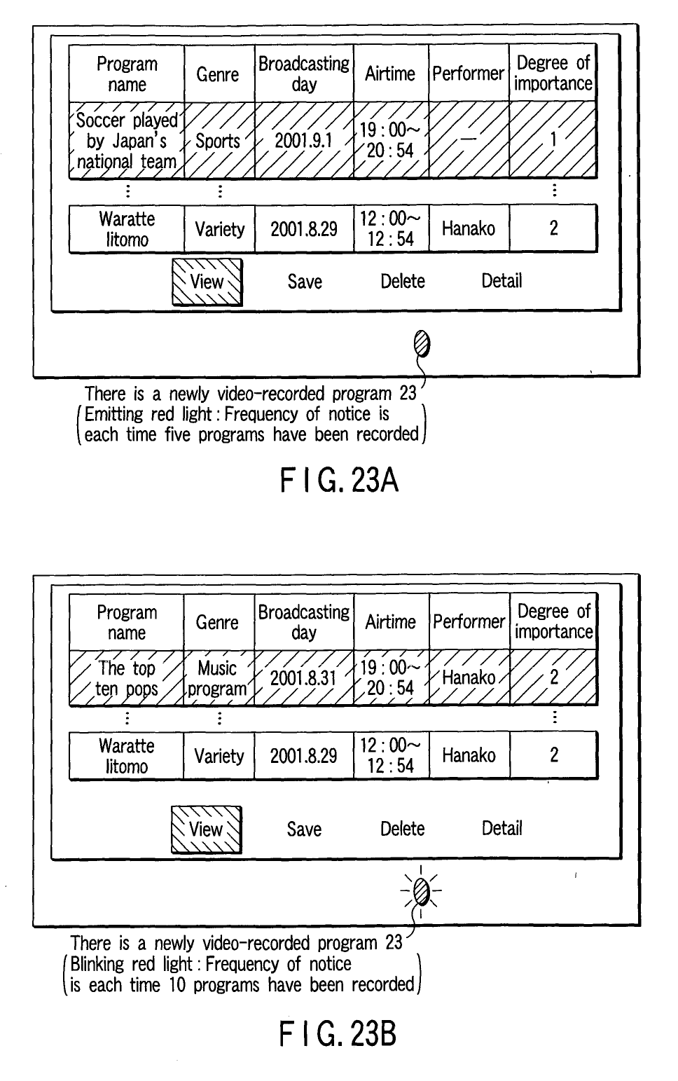

Furthermore, the reservation managing section 15 obtain the number of programs with the recording complete flags set from the program reservation table (S22f) and compares the obtained number with a preset value (S22g). For example, when the obtained number is equal to or greater than a preset value of 5, the reservation managing section 15 causes the notice section 22 to give notice (S22h). As a result, the LED 23 emits red light, thereby informing the user, as shown in FIG. 23A. When the obtained number is smaller than the preset value, the reservation managing section 15 terminates the process.

The preset value may be set by the user from the input section 14 or set to a default value. This prevents the user from being prompted to make a choice of processing each time a program is newly recorded, which reduces the burden on the user.

Next, a ninth embodiment of the present invention will be explained. In the case where the user has canceled the choice of program processing after being informed that the number of video-recorded programs has become equal to or exceeded the preset value, the number of video-recorded programs is displayed in a different way when the number has become equal to or exceeded a second preset value. This enables the user to grasp the present number of video-recorded programs and use the number as a guide in setting the processing of programs.

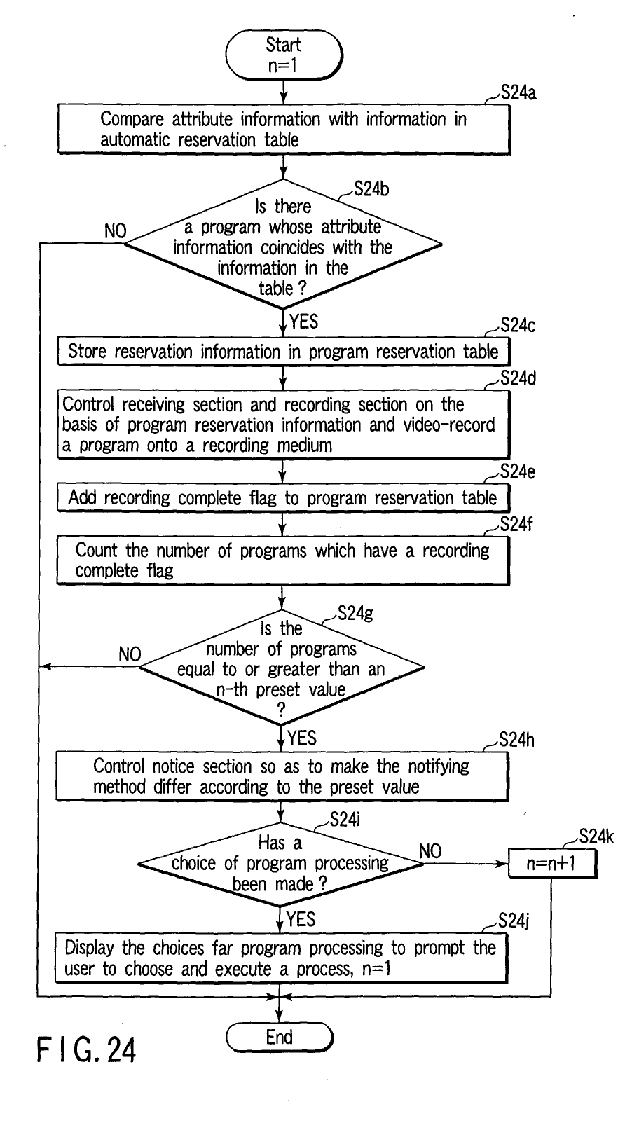

FIG. 24 is a flowchart to help explain the operation when a plurality of preset values are used. In FIG. 24, step S24a to step S24f are the same as step S22a to step S22f in FIG. 22.

The reservation managing section 15 compares the number of video-recorded programs with an n-th preset value (S24g). The initial value of n is set to 1 and an n-th preset value may be set separately in the range of, for example, n=1 to m (e.g., when n=1, the first preset value=5, when n=2, the second preset value=7 and so on). Alternatively, an n-th preset value may be set automatically using the equation PRESET VALUE=INITIAL VALUE×n (e.g., with an initial value of 5, when n=1, the first preset value=5, when n=2, the second preset value 10 and so on).

When the number of video-recorded programs is equal to or greater than the n-th preset value, a different notice is given for each preset value (S24h). For example, when the number is equal to or greater than the first preset value, the LED 23 emits red light as shown in FIG. 23A. When the number is equal to or greater than the second present value, the LED 23 blinks in red as shown in FIG. 23B. In this way, the notice section 22 is controlled so as to change the way of giving notice according to the number of video-recorded programs.

For example, on being informed that the number of video programs is equal to or greater than the first preset value, the user determines whether to make a choice of program processing (S24i). To make a choice of program processing, the user presses the red key on the remote controller 24 once. Then, as shown in FIG. 23A, a list of video-recorded programs is displayed and the choices for program processing are shown (S24j). When a process is chosen and carried out, n=1 is substituted.

When a choice of processing is not made, for example, the user presses the cancel key. Then, the calculation n=n+1 is preformed (S24k). In the example, n=2 is given. From this time on, the number of video-recorded programs is compared with the second preset value.

Then, when the number of video-recorded programs has become equal to or exceeded the second preset value, the LED 23 blinks in red as shown in FIG. 23B, informing the user of the fact. Pressing the red key on the remote controller 24 twice causes a list of video-recorded programs and the choices for program processing to be displayed. When the cancel key is pressed, n=3 is given.

As described above, providing a plurality of preset values enables the user to grasp the number of video-recorded programs and use the number as a guide in making a choice of program processing. This further reduces the burden on the user.

Next, a tenth embodiment of the present invention will be explained. When a program is newly video-recorded a specific time after the user last made a choice of the processing of a newly video-recorded program, the user is informed of the fact, not the number of newly video-recorded programs. This reduces the chances that the user will be prompted to make a choice of processing, which reduces the burden on the user.

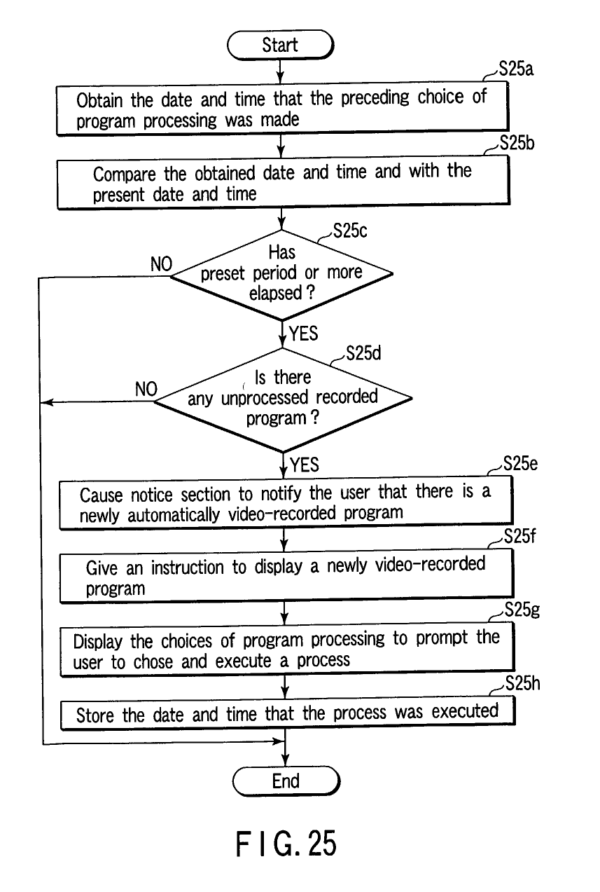

FIG. 25 is a flowchart to help explain the operation of informing the user when a program is newly video-recorded a specific time after the user last made a choice of the processing of a newly video-recorded program.

The reservation managing section 15 obtain the date and time that the program processing was last carried out from the program reservation table storage section 17 (S25a). The section 15 compares the obtained date and time and a preset period of time (e.g. one week) with the present date and time (S25b), thereby determining whether the preset period has elapsed since a program was last processed (S25c).

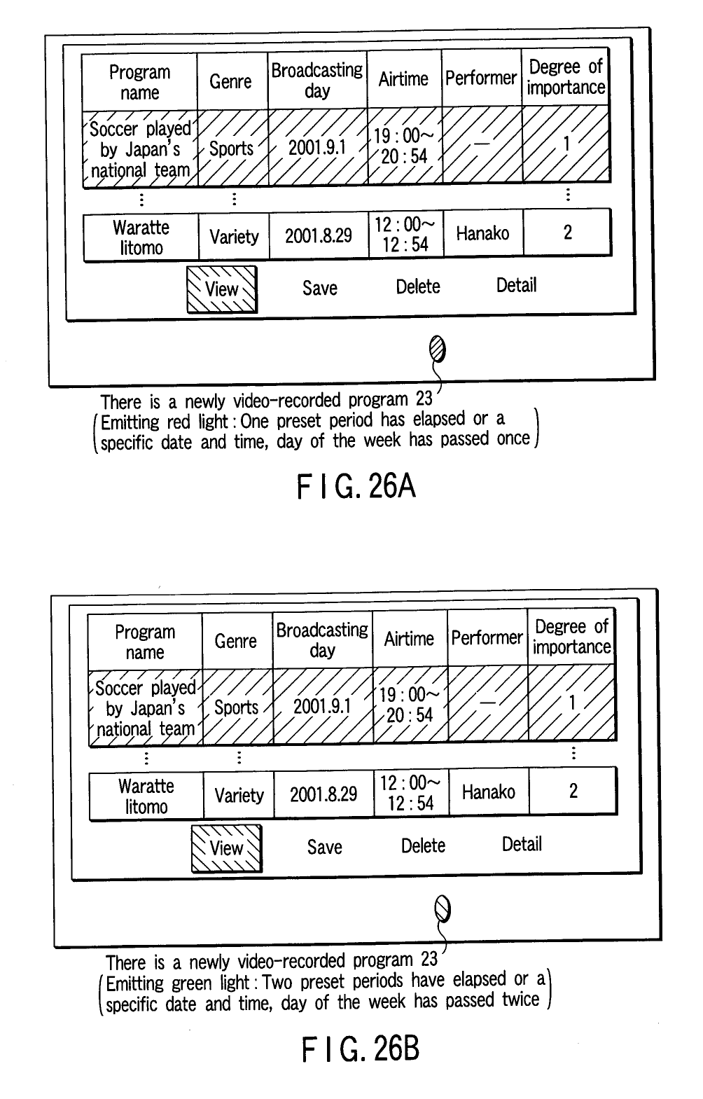

If the elapsed time is equal to or exceeds the preset period, the reservation managing section 15 senses whether there is any unprocessed program whose recording complete flag is set in the program reservation table storage section 17 (S25d). If there is an unprocessed video-recorded program, the section 15 causes the notice section 22 to give notice (S25e). Then, as shown in FIG. 26A or 26B, this causes the LED 23 to emit red or green light, thereby informing the user of the fact.

The period of time may be set by the user from the input section 14 or set to a default value. When there is an unprocessed program, the user causes a list of newly video-recorded programs and their content to be displayed (S25f) as shown in FIG. 26A or 26B. Then, the user chooses one of the displayed choices and executes the process (S25g).

After the chosen process is executed, the date and time that the process was executed are stored in the program reservation table storage section 17, referring to the present date and time (S25h). As described above, informing the user whether there is any video-recorded program at regular intervals of time reduces the chances that the user will make a choice of processing, which reduces the burden on the user.

Next, an eleventh embodiment of the present invention will be explained. In the eleventh embodiment, after a preset period of time has elapsed, the method of giving notice is changed according to the number of video-recorded programs as described above. When the number of recorded programs is still small, the user does not make a choice of processing. Then, for example, the user may operate the cancel key on the remote controller 24 to leave the programs as they are.

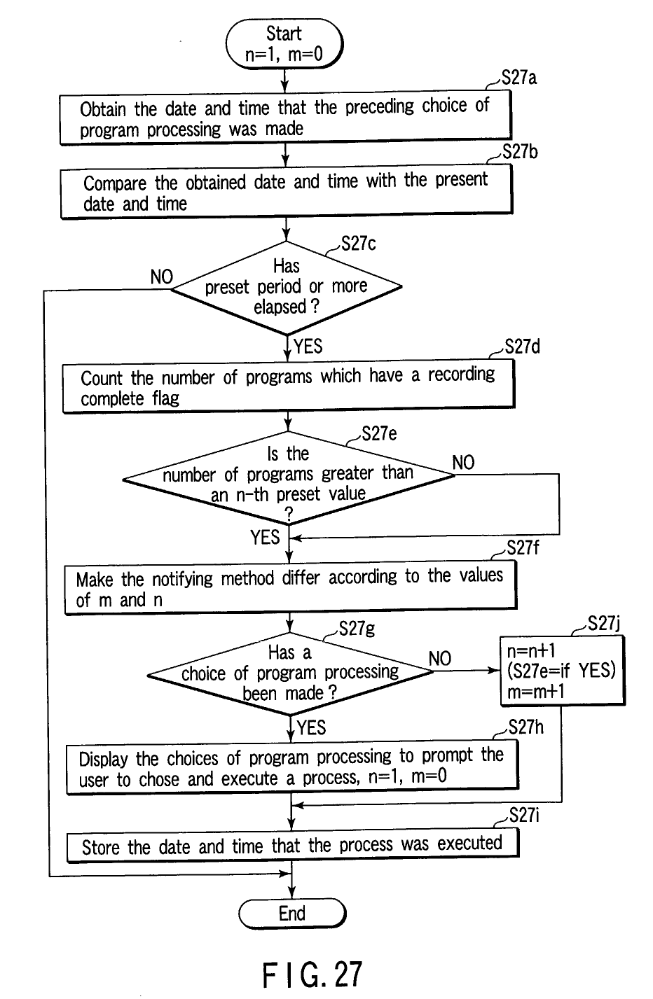

FIG. 27 is a flowchart to help explain the operation in a case where the user does not make a choice of processing when the number of recorded programs is still small and leaves the programs as they are. In FIG. 27, step S27a to step S27c are the same as step S25a to step S25c in FIG. 25.

When the preset period or more has elapsed since the preceding choice of processing, the reservation managing section 15 obtain the number of video-recorded programs from the program reservation table storage section 17 (S27d) and determines whether the number of video-recorded programs is equal to or greater than an n-th preset value (S27e).

Then, on the basis of the n-th preset value and the number m of times (the initial value m=0) the user cancelled the choice of program processing, the reservation managing section 15 causes the notice section 22 to give different notice (S27f).

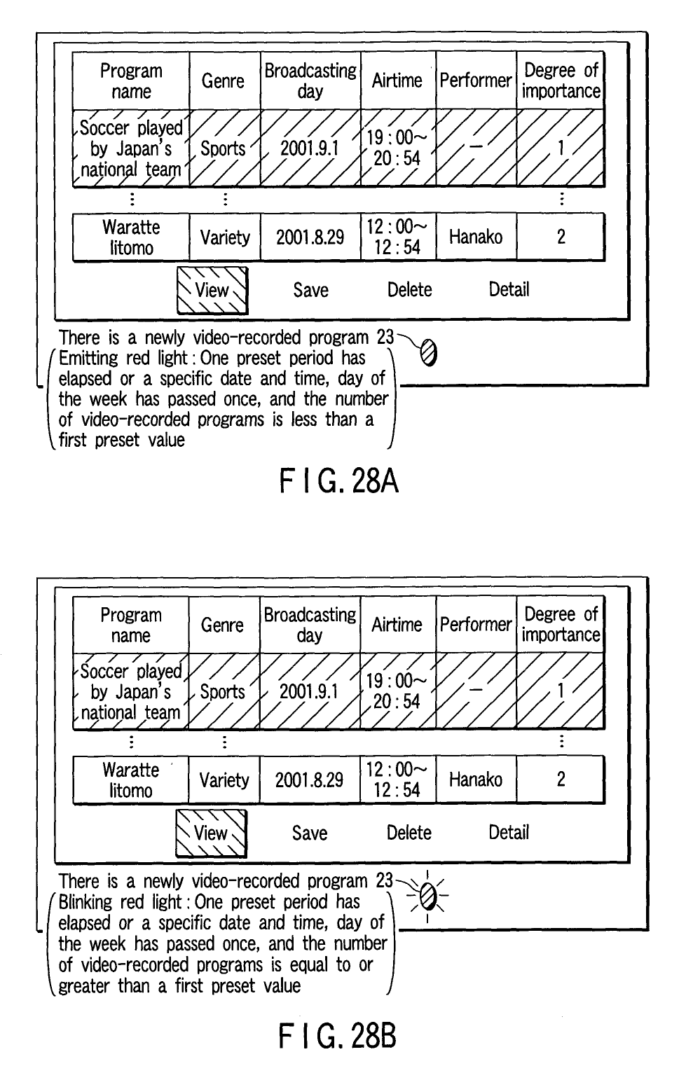

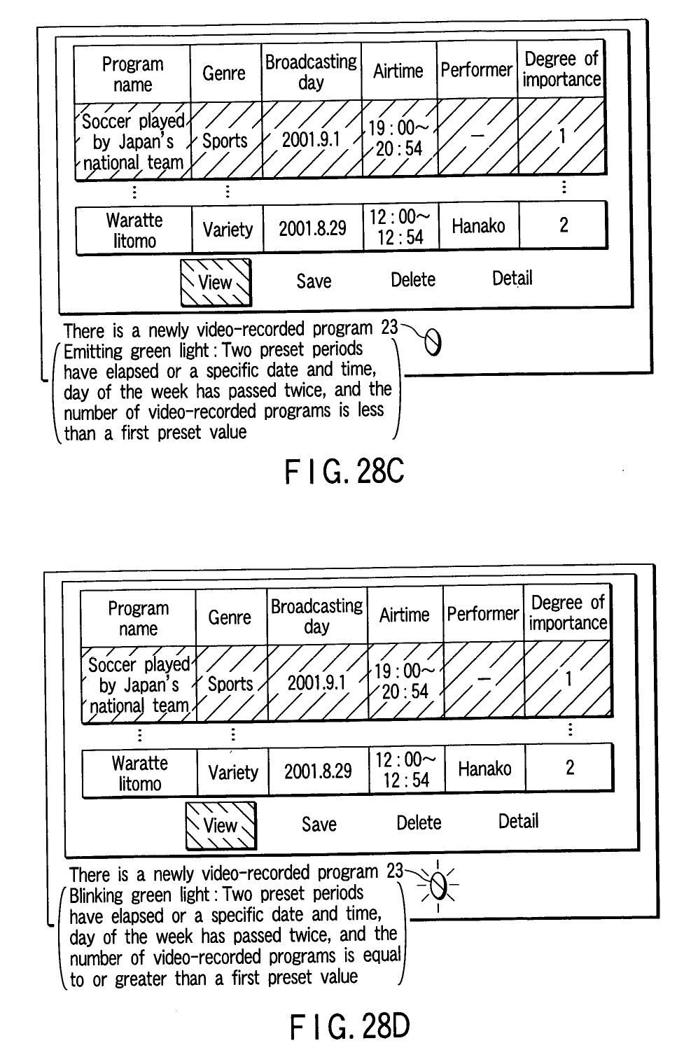

For example, with m=0 and n=1 as the initial value, when a preset period of time or more has elapsed, if the number of video-recorded programs is smaller than a first preset value, the LED 23 emits red or green light, thereby giving notice as shown in FIG. 28A or FIG. 28C. If the number of video-recorded programs is equal to or greater than the first preset value, the LED 23 blinks in red or green, thereby giving notice as shown in FIG. 28B or FIG. 28D.

When being informed that the preset period of time or more has elapsed, the user determines whether to make a choice of program processing (S27g). To make a choice of program processing, on being informed by the red or green light from the LED 23, the user presses the red or green key on the remote controller 24 once, and on being informed by the red or green blinking light from the LED 23, the user presses the red or green key on the remote controller 24 twice. As a result, a list of video-recorded programs and the choices of program processing are displayed as shown in FIGS. 28A to 28D, which enables the user to make a choice of processing and execute the chosen process (S27h). At this n=1 and m=0 are substituted. After the program is processed, the date and time that the process was executed are stored in the program reservation table storage section 17 (S27i).

When not making a choice of processes, for example, the user presses the cancel key on the remote controller 24. Then, when the LED 23 is emitting red light, the equation m=m+1 is calculated. When the LED 23 is blinking in red, the equations m=m+1 and n=n+1 are calculated (S27j).

In the example, with the LED 23 emitting red light, when the user presses the cancel key, this gives m=1 and n−1. After a preset period of time has elapsed, if the number of video-recorded programs is smaller than the first preset value, the LED 23 emits green light, thereby giving notice. If the number of video-recorded programs is equal to or larger than the first preset value, the LED 23 blinks in green, thereby giving notice.

With the LED 23 blinking in red, when the user presses the cancel key, this gives m=1 and n=2. After the preset period of time has elapsed, if the number of video-recorded programs is smaller than the second preset value, the LED 23 blinks in green, thereby giving notice. If the number of video-recorded programs is equal to or greater than the second preset value, the LED 23 blinks in green at a different speed, thereby giving notice.

As described above, changing the way of giving notice enables the user to understand at a glance how many video-recorded programs there are and for how long a choice of program processing has not been made and use the number and the period of time as a guide in making a choice of program processing.

Next, a twelfth embodiment of the present invention will be explained. In the twelfth embodiment, after a preset period of time has elapsed, the way of giving notice is changed according to the degree of importance of a video-recorded program. When the degree of importance of the recorded program is low, the user does not make a choice of processing. For example, the user may press the cancel key on the remote controller 24 to leave the program as it is.

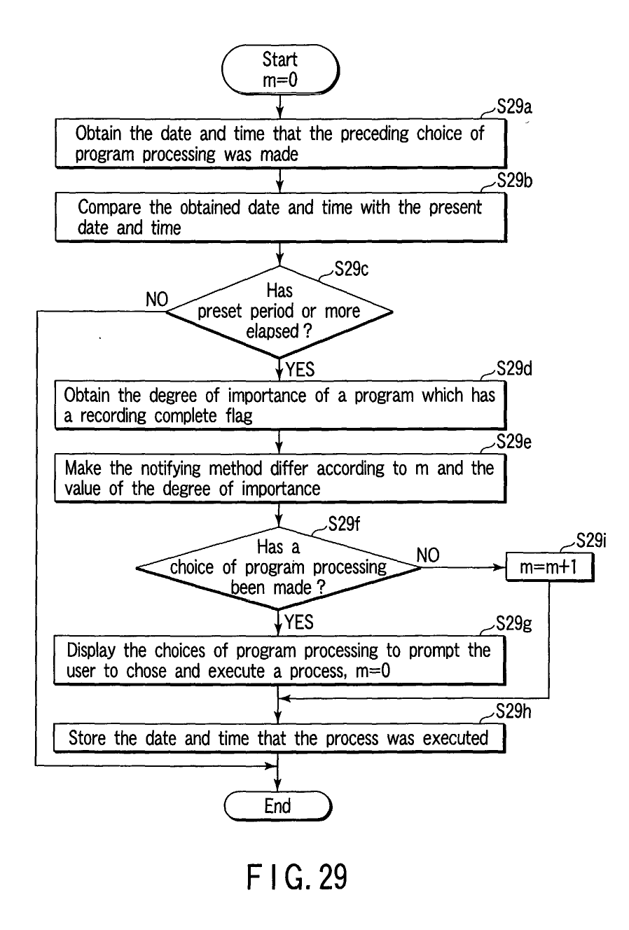

FIG. 29 is a flowchart to help explain the operation in a case where the user presses the cancel key on the remote controller 24 to leave the recorded program as it is when the degree of importance of the program is low. In FIG. 29, step S29a to step S29c are the same as step S25a to step S25c in FIG. 25.

When a preset period of time or more has elapsed since the preceding choice of processes, the reservation managing section 15 obtain the degree of importance of the video-recorded program from the program reservation table storage section 17 (S29d). On the basis of the degree of importance and the number m (the initial value m=0) of times the user cancelled the choice of program processing, the reservation managing section 15 causes the notice section 22 to give different notice (S29e).

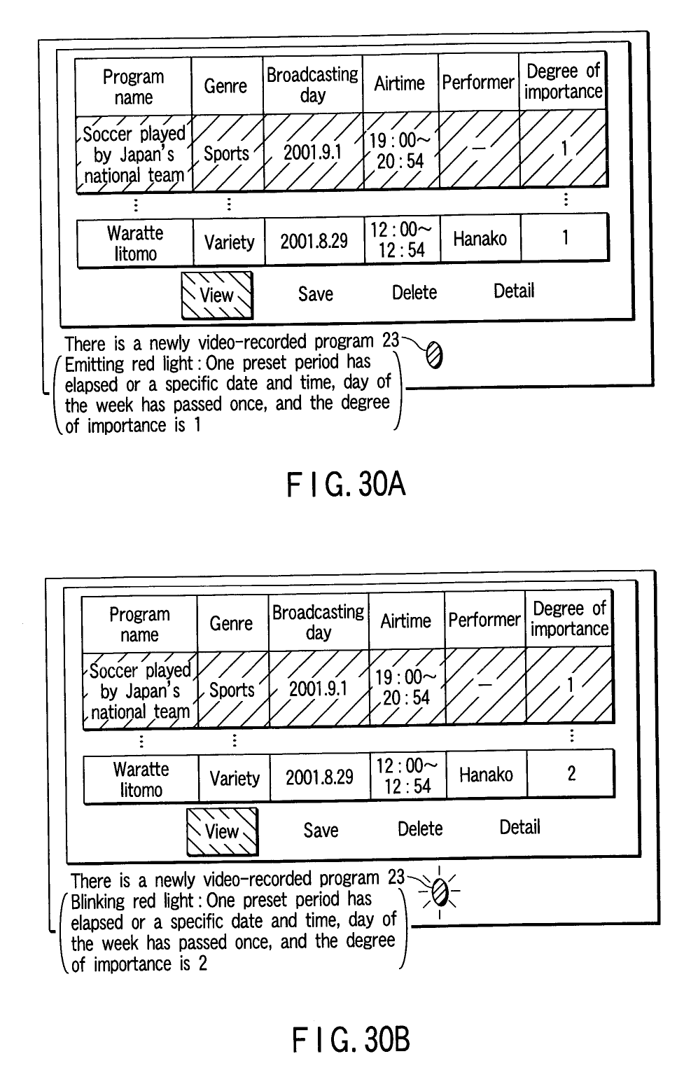

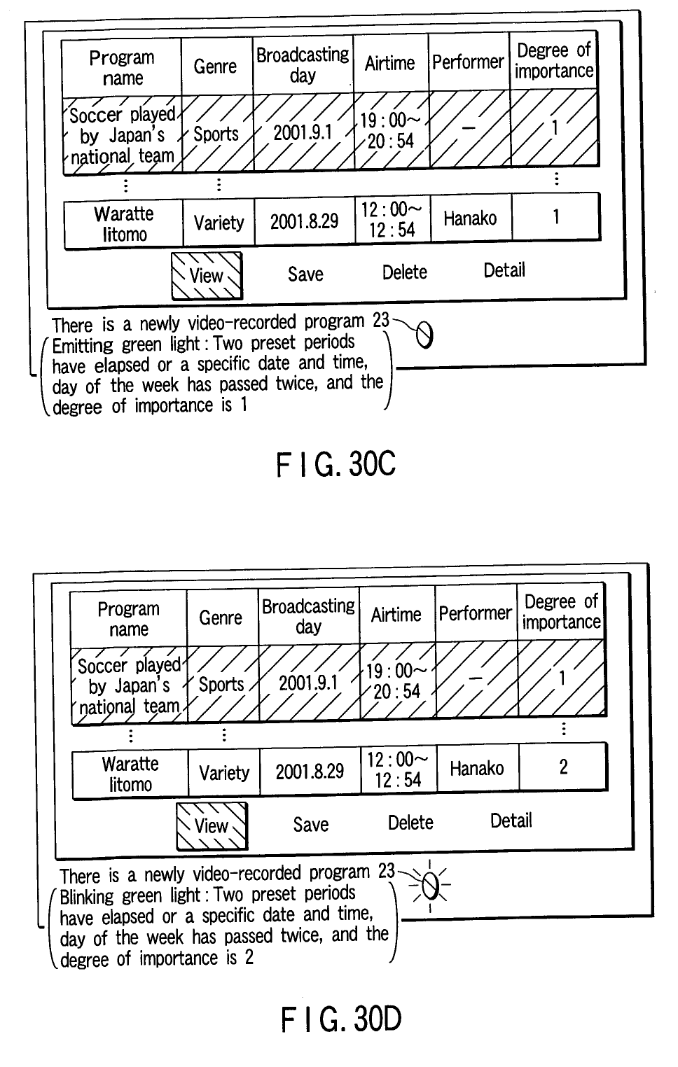

For example, with m=0, when there is a video-recorded program with degree of importance 1 after a preset period of time has elapsed, the LED 23 emits red light, giving notice as shown in FIG. 30A. When there is not a program with degree of importance 1 and there is a program with degree of importance 2, the LED 23 blinks in red, giving notice as shown in FIG. 30B.

On being informed that the preset period of time or more has been elapsed, the user determines whether to make a choice of program processing (S29f). To make a choice of program processing, on being informed by the red or green light from the LED 23, the user presses the red or green key on the remote controller 24 once, and on being informed by the red or green blinking light from the LED 23, the user presses the red or green key on the remote controller 24 twice. As a result, a list of video-recorded programs and the choices of program processing are displayed as shown in FIGS. 30A to 30D, which enables the user to make a choice of processes and execute the chosen process (S29g). At this time, m=0 is substituted. After the program is processed, the date and time that the process was executed are stored in the program reservation table storage section 17 (S29h).

When not making a choice of processing, for example, the user presses the cancel key on the remote controller 24. Then, the equation m=m+1 is calculated (29i) and the date and time at that time are stored in the program reservation table.

In the example, with the LED 23 emitting red light, when the user presses the cancel key, this gives m=1. After the next preset period of time has elapsed, if there is any program with degree of importance 1, the LED 23 emits green light, thereby giving notice. If there is not a video-recorded program with degree of importance 1 and there is a video-recorded program with degree of importance 2, the LED 23 blinks in green, thereby giving notice.

As described above, changing the way of giving notice enables the user to understand at a glance what degree of importance the available video-recorded programs have and for how long a choice of program processing has not been made and to use the degree of importance and the period of time as a guide in making a choice of program processing.

Next, a thirteenth embodiment of the present invention will be explained. In the thirteenth embodiment, when there is a newly video-recorded program on a specific date and time or a specific day of the week, not after a specific preset period of time has elapsed, the user is informed of the fact, which reduces the chances that the user will make a choice of processing and therefore reduces the burden on the user.

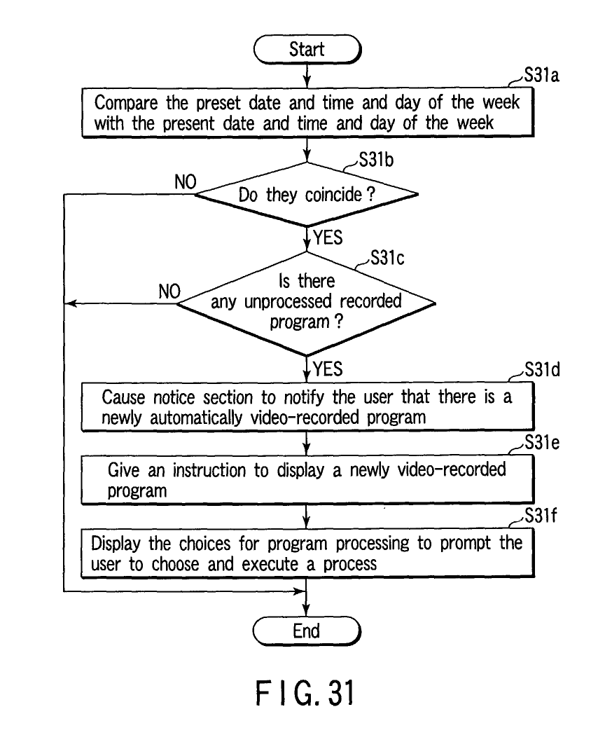

FIG. 31 is a flowchart to help explain the operation of informing the user when a new program has been video-recorded on a specific date and time or a specific day of the week. The reservation managing section 15 compares the present date and time with the preset specific date and time or a specific day of the week (S31a), thereby determining whether they coincide (S31b).

If the present date and time coincide with the preset date and time or day of the week, the reservation managing section 15 obtain an unprocessed program whose recoding complete flag is set from the program reservation table in the program reservation table storage section 17 (S31c). If there is such a program, the section 15 causes the notice section 22 to give notice. As a result, as shown in FIG. 26A, the LED 23 emits red light, thereby informing the user (S31d).

The date and time or day of the week may be set by the user from the input section 14 or set to default values.

When there is a newly video-recorded program, the user gives an instruction to display a list of newly video-recorded programs and their content (S31e) as shown in FIG. 26A. Then, the user chooses one of the choices for the displayed programs and executes the process (S31f).

As described above, notifying the user whether there is any newly video-recorded program on a specific date and time or a specific day of the week reduces the chances that the user will make a choice of processing and therefore reduces the burden on the user.

Next, a fourteenth embodiment of the present invention will be explained. In the fourteenth embodiment, the method of giving notice is changed according to the number of video-recorded programs on a specific date and time or a specific day of the week. When the number of recorded programs is still small, the user does not make a choice of processing. Then, for example, the user may press the cancel key on the remote controller 24 to leave the programs as they are.

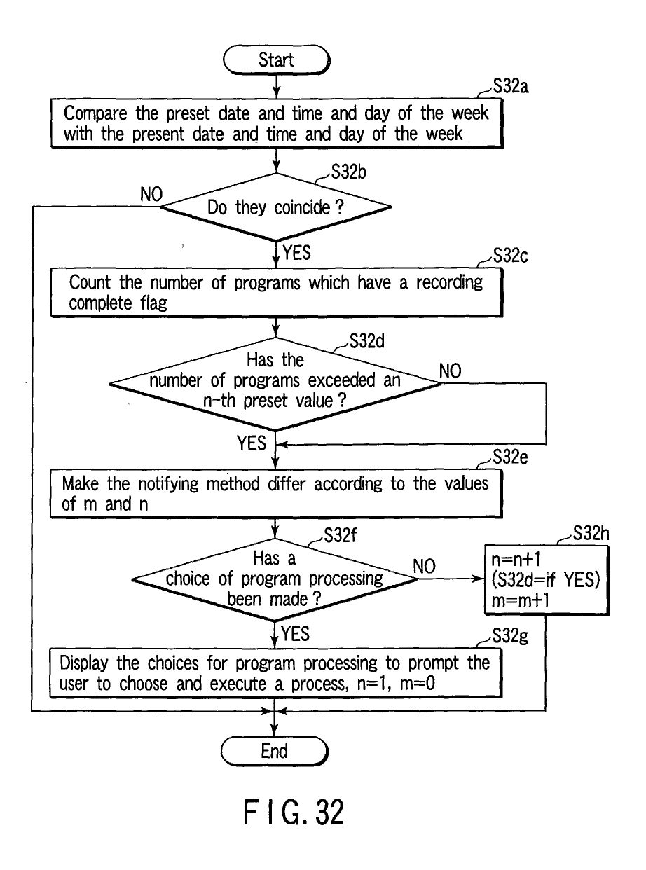

FIG. 32 is a flowchart to help explain the operation of changing the way of giving notice according to the number of video-recorded programs in notifying a video-recorded program on a specific date and time or a specific day of the week. In FIG. 32, step S32a and step S32b are the same as step S31a and step S31b in FIG. 31 and step S32c to S32h are the same as step S27d to step S27h and step S27j in FIG. 27. The notifying method and the displaying method are the same as those described in FIGS. 28A to 28D.

As described above, changing the way of giving notice enables the user to understand at a glance how many video-recorded programs there are and for how long a choice of program processing has not been made and use the number and the period of time as a guide in making a choice of program processing.

Next, a fifteenth embodiment of the present invention will be explained. In the fifteenth embodiment, the way of giving notice is changed according to the degree of importance of a video-recorded program on a specific date and time or a specific day of the week. When the degree of importance of the recorded program is low, the user does not make a choice of processing. For example, the user may press the cancel key on the remote controller to leave the program as it is.

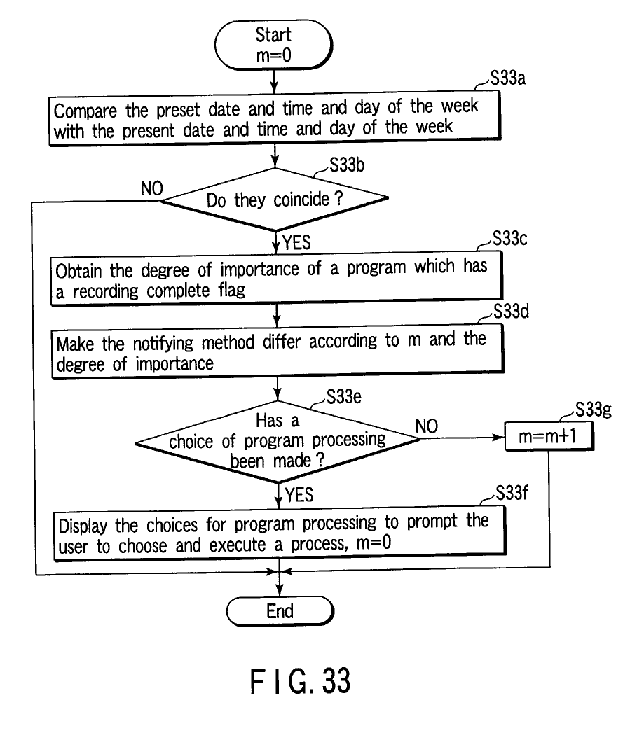

FIG. 33 is a flowchart to help explain the operation of changing the way of giving notice according to the degree of importance of a video-recorded program in notifying the video-recorded program on a specific date and time or a specific day of the week. In FIG. 33, step S33a and step S33b are the same as step S31a and step S31b in FIG. 31 and step S33c to S33g are the same as step S29d to step S29g and step S29i in FIG. 29. The notifying method and the displaying method are the same as those described in FIGS. 30A to 30D.

As described above, changing the way of giving notice enables the user to understand at a glance how many video-recorded programs with a specific degree of importance there are and for how long a choice of program processing has not been made and to use the degree of importance and the period of time as a guide in making a choice of program processing.

While in the above embodiments, the notifying method and the displaying method are changed according to the genre in the attribute information or the degree of importance of the reservation information, the notifying method and the displaying method may be changed according to other items included in the attribute information or reservation information.

In the above embodiments, a single LED 23 has been used to inform the user of the state. A plurality of LEDs may be used for the same purpose. An OSD (on screen display) or sound may be used to notify the user of the state.

Moreover, although in the above embodiments, a digital broadcast receiving apparatus with a display section 21 has been used, the present invention may be applied to, for example, a set-top box separated from the display section 21.

What is claimed is:

1. A program video-recording apparatus comprising:
a setting section which sets reservation information;
a reserved video-recording section which correlates the reservation information set at the setting section with attribute information added to input program information and retrieves and video-records a program to be video-recorded; and
a notice section which gives notice that a program has been video-recorded by the reserved video-recording section.

2. A program video-recording apparatus according to claim 1, wherein said notice section causes the program video-recorded by said reserved video-recording section to differ in the form of notice according to the content of each item included in said attribute information.

3. A program video-recoding apparatus according to claim 1, wherein said notice section causes the program video-recorded by said reserved video-recording section to differ in the form of notice according to the content of each item included in said reservation information.

4. A program video-recoding apparatus according to claim 1, wherein said notice section causes the program video-recorded by said reserved video-recording section to differ in the frequency of notice according to the content of each item included in said reservation information.

5. A program video-recoding apparatus according to claim 1, wherein said notice section gives notice when the number of programs video-recorded by said reserved video-recording section has exceeded a preset value.

6. A program video-recoding apparatus according to claim 1, wherein said notice section causes the form of notice to differ according to the number of programs video-recorded by said reserved video-recording section.

7. A program video-recoding apparatus according to claim 1, further comprising a program display section which displays a list of programs video-recorded by said reserved video-recording section.

8. A program video-recoding apparatus according to claim 7, wherein said program display section displays the programs video-recorded by said reserved video-recording section by the content of each item included in said attribute information.

9. A program video-recoding apparatus according to claim 7, wherein said program display section displays the programs video-recorded by said reserved video-recording section by the content of each item included in said reservation information.

10. A program video-recoding apparatus according to claim 7, further comprising:
a select section which chooses a desired program from the list of programs displayed by said program display section; and
a choice display section which displays the choices for prompting that the program chosen at the select section be subjected to a specific process.

11. A program video-recoding apparatus according to claim 10, wherein said notice section gives notice when a specific period of time has elapsed since the process corresponding to the choice made at said choice display section was last carried out and a program has been newly video-recorded in the specific period of time.

12. A program video-recording method comprising:
setting reservation information;
correlating the set reservation information with attribute information added to input program information and retrieving and video-recording a program to be video-recorded; and
giving notice that a program has been video-recorded.

13. A program video-recording method according to claim 12, wherein said act of giving notice causes the video-recorded program to differ in the form of notice according to the content of each item included in said attribute information or said reservation information.

14. A program video-recording method according to claim 13, further comprising displaying video-recorded programs by the content of each item included in said attribute information or said reservation information by performing an operation corresponding to said form of notice.

15. A program video-recording method according to claim 14, further comprising
choosing a desired program from the list of programs displayed by the content; and
displaying the choices for prompting that the chosen program be subjected to a specific process.

16. A program receiving apparatus comprising:
a receiving section which receives a broadcast program and acquires program information and its attribute information;
a setting section which sets reservation information;
a reserved video-recording section which correlates the reservation information set at the setting section with the attribute information acquired at said receiving section and retrieves and video-records a program to be video-recorded; and
a notice section which gives notice that a program has been video-recorded by the reserved video-recording section.

17. A program receiving apparatus according to claim 16, wherein
said setting section is capable of setting a specific degree of importance for the set reservation information.

18. A program receiving apparatus according to claim 16, further comprising
a program display section which displays a list of programs video-recorded by said reserved video-recording section.

19. A program receiving apparatus according to claim 18, further comprising
a select section which chooses a desired program from the list of programs displayed by said program display section; and
a choice display section which displays the choices for prompting that the program chosen at the select section be subjected to a specific process.
